(19) United States
(12) Patent Application Publication
(10) Pub. No.: US 2002/0178115 A1
(43) Pub. Date: Nov. 28, 2002

(54) System and method for supplying credit card information

(76) Inventor: Dong-Seok Seo, Seoul (KR)

Correspondence Address: ARMSTRONG,WESTERMAN & HATTORI, LLP, 1725 K STREET, NW., SUITE 1000, WASHINGTON, DC, 20006, US

(21) Appl. No.: 10/050,174

(22) Filed: Jan. 18, 2002

(30) Foreign Application Priority Data
May 28, 2001 (KR) 2001-29522

(51) Int. Cl. G06F 17/60

(52) U.S. Cl. 705/39

(57) ABSTRACT

A system for supplying credit card information includes a user terminal; a credit card company server including a membership information database unit, a membership authenticating unit, a credit card information database unit, an information retrieval unit, an approval inquiry unit, and a communication unit; and a corporation server including a communication unit, a data storage unit, a control unit, and a functional unit; wherein the functional unit includes a request section requesting the credit card company server to transmit the credit card information, a inquiry section providing an end user with the corporation credit card information through an intra-network, a report section helping an end user to make a report about the transaction of the corporation credit card on the base of the information received from the credit card company server, a file service section converting a data of the corporation into a electronic file in order to transmit the information to the outside of the corporation, and a administration section administering the credit card transaction information and history,

### BACKGROUND OF THE INVENTION

1. Field of the Invention

The present invention relates to a credit card information tracking system. More particularly it relates to a system and a method for supplying credit card payment and transaction information to a corporation or a juristic person.

2. Discussion of the Related Art

Generally, the credit cards belonging to the corporation or juristic person (often referred to as the corporation) are classified into two types—the credit card that the staffs of the corporation can jointly use and the credit card that is issued for and used by only one of the corporation's staffs. Hereinafter, these credit cards for the corporation or juristic person are referred to as corporate card or corporate credit card.

The most corporations do not have any data system that collects and provides information about all corporate card transactions. Therefore, whenever they purchase the goods and pay the bill using the corporate credit card, each matter of transaction and information should be input and recorded, independently. However, as the corporation owns a lot of credit cards and/or as each card holder or each staff of the corporation uses the credit card many times, it is very difficult to control each card transaction and invoice. Namely, although it is convenient to use the corporate credit card, the use of credit card is not expanded because of the above-described difficulties in administering credit card transaction.

On the ground of above-mentioned problems, it is required that a system and method for tracking the corporate credit card transaction, controlling the spendings using the corporate credit card, and supplying the corporate credit card information.

### SUMMARY OF THE INVENTION

It is, therefore, an object of the invention to provide a system and a method for controlling the use of corporate credit card in order to substantially obviate one or more of the problems described above.

Another object of the present invention is to provide a system and a method that itemize the corporate credit card transaction and administer the data for the use of the corporate credit card.

Another object of the present invention is to provide direct payment system and method without a credit card payment service provider.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

In order to achieve the above object, an embodiment in accordance with the principles of the present invention provides a system for supplying credit card information including a user terminal, a credit card company server, and a corporation server.

The user terminal or client communicates with the corporation server through LAN or intranet. The credit card company server includes a membership information database unit storing member's information, a credit information database for storing credit information of the card holders; a membership authenticating unit authorizing membership, a credit card information database unit storing information about the use of the credit card according to each individual and each corporation, an information retrieval unit searching the credit card transaction history in the credit card information database unit in accordance with a transmission request, an approval unit for determining approval of a credit card transaction, and a communication unit transmitting the information found in the information retrieval unit and the answer to the credit card transaction approval inquiry. The corporation server includes a communication unit controlling communication between the corporation server and outbound network systems, a user registry unit having users' information for the corporation server, a data storage unit storing data generated in the corporation server, a control unit having an arithmetic unit, and a functional unit. The functional unit includes a request section requesting the credit card company server to transmit the credit card information, a inquiry section providing an end user with the corporation credit card information through an intra-network, a report section helping an end user to make a report about the use of the corporation credit card on the base of the information received from the credit card company server, a file service section converting a data of the corporation into a electronic file in order to transmit the information to the outside of the corporation server or vice versa, and a administration section administering the credit card transaction information and history.

The functional unit further includes an approval section that functions as providing a direct payment system without an Internet payment service provider when the direct transaction with other corporations is complete using the corporation credit card. The approval section may be conducted by a terminal selected from a group consisting of a Palm PC, a Handheld PC and a POS (Point Of Sale) terminal.

Additionally, the functional unit further includes a merchant inquiry section that helps the end user of the distributor company to inquire about the approval of the transaction processed or will be processed for that company, an advance settlement section that provides a function asking the credit card company server a payment in advance, and an advance payment section for a corporation to directly pay a credit card bill in advance.

Here in the present invention, the corporation server is a computer-implemented Internet access device, the data storage unit includes a cash memory, RAM, ROM and hard disks, and the control unit includes a central processing unit (CPU). The credit card company server further includes an electronic banking system that cooperates with the credit card company server in supplying credit card information.

The system for supplying the credit card information further includes a communication intermediary that intermediates between the corporation server and the credit card company server, transmits the credit card information to the corporation server by way of converting the data from the credit card company server to a format compatible with the corporation server, and converts the data from the corporation server to a format understood by the credit card company server.

In another aspect, the principles of the present invention provide a method for supplying credit card information in a system for supplying credit card information which includes a plurality of user terminals, a corporation server communicating with the user terminal through a computer-implemented communication infrastructure, and a credit card company server connected to the corporation server through the Internet, the method includes the steps of constructing a database having corporate credit card transaction history and information according to each corporation in the credit card company server; connecting the corporation server to the credit card company server; requesting the credit card company server to send the credit card transaction information and history; requesting a credit card transaction approval to the credit card company server; responding to the request of the corporation server; and searching the credit card transaction information and history sent to the corporation server using the user terminal.

In the above-mentioned method, requesting the credit card transaction approval is conducted by a terminal selected from a group consisting of a Palm PC, a Handheld PC and a POS (Point Of Sale) terminal.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate an embodiment of the present invention and together with the description serve to explain the principles of that invention.

In the drawings:

FIG. 1 is a schematic structural representation of a system for supplying corporate credit card information according to a first embodiment of the present invention;

FIG. 2 ; illustrates a structural diagram of an exemplary credit card company server of FIG. 1;

FIG. 3 illustrates a structural diagram of an exemplary functional unit of a corporation server of FIG. 1

FIG. 4 is a data flow diagram showing how the data are processed by the system according to the first embodiment of the present invention; and

FIG. 5 is a schematic structural representation of a system for supplying corporate credit card information according to a second embodiment of the present invention.

### DETAILED DESCRIPTION OF THE ILLUSTRATED EMBODIMENT

Reference will now be made in detail to illustrated embodiments of the present invention, an example of which is shown in the accompanying drawings. Wherever possible, the same reference numbers will be used throughout the drawings to refer to the same or the parts.

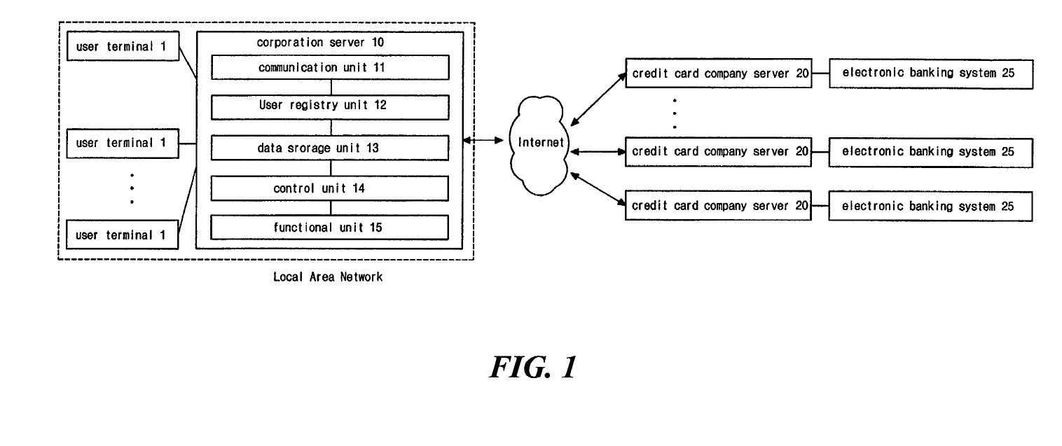

FIG. 1 is a schematic structural representation of a system for supplying corporate credit card information according to a first embodiment of the present invention. Referring to FIG. 1, the system for supplying the corporate credit card transaction information or history includes: a plurality of user terminals 1; a corporation server 10 installed in the corporation's inbound infrastructure or intranet; and a credit card company servers 20. The corporation server 10 communicates with the credit card company server 20 over the Internet. Each user terminal 1 communicates with the corporation's network system through an intra-network or LAN. Additionally, the plurality of user terminal 1 can be an Internet access device, e.g., a personal computer, or PDA.

The corporation server 10 is an Internet access device, e.g., a computer-implemented system, and acts as a server for providing the corporate credit card transaction information or history. As components for the corporation server 10, there are at least a communication unit 11, a users registry unit 12, a data storage unit 13, a control unit 14, and a functional unit 15. The functional unit 15 is important to achieve a principle of the invention. The communication unit 11 may be modem, network card, ISDN connection, etc such that the communication unit 11 controls communication between the corporation server 10 and outbound network systems. The users registry unit 12 is for controlling access of the corporation server 10 from the terminal, therefore preferably has a database of information such as passwords of the terminals or users that can access the corporation server 10. The data storage unit 13 includes a cash memory, RAM, ROM and hard disks such that it stores all the data generated in the corporation server 10. The control unit 14 includes an arithmetic unit, such as a central processing unit (CPU) in the computer.

Furthermore, the functional unit 15 is software that executes Internet access, credit card information record and edit, and data transmission and reception, in order to accomplish the credit card information service supply. This software as the functional unit 15 can be downloaded from the credit card company server 20 through the Internet and/or other on-line computer network. Additionally, the software can be downloaded from a service provider conducting the embodiment of the present invention. Further, the compact disk (CD), which stores the software as the functional unit 15 for the present invention, can be provided by the credit card company or other service provider. The software as the functional unit 15 in the present invention interconnects the corporation server 10 to the credit card company server 20, and can be updated through the internet and/or other computer network.

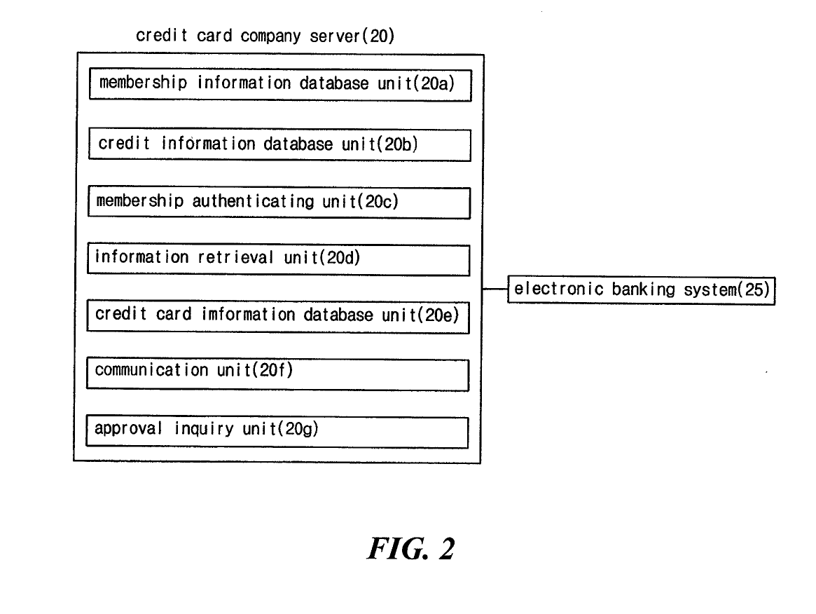

Now, referring to FIG. 2, the credit card company server 20 for each credit card company includes: a membership information database unit 20a storing all member's information; a credit information database unit 20b for checking the credit of the card holder in order to determine the approval of the credit transaction; a membership authentication unit 20c for determining the access of the corporation server; an information retrieval unit 20d searching the credit card transaction and/or invoice in the credit card information database unit 20d in accordance with a transmission request; an approval unit 20g conducting the search of the credit database unit 20b; and a communication unit 20f transmitting the information found in the information retrieval unit 20c and the answer to the credit card transaction approval inquiry. Further, the credit card company server 20 can be interconnected with an electronic banking system 25 in order to efficiently transmit accurate information to the corporation server 10. Additionally, the credit card information database unit 20d includes a lot of information, e.g., credit card number, division name of the corporation, business number, category, merchant name, merchant number, merchant's address and/or phone number, amount, commission, classification (domestic or abroad), approval date, purchasing date, scheduled settlement date, settlement account, approval number, etc.

Moreover, the credit card company server 20 provides an on-line service to the functional unit 15 of the corporation server 10 to update the software and maintain optimized circumstance according to the present invention. The electronic banking system 25 works together with the credit card company server 20 in order to provides the corporate credit card information supply system according to the present invention. Namely, the electronic banking system 25 is interconnected with the credit card company server 20 through the Internet, on-line computer network or other communication devices. A special software unit, which is used in communication between the credit card company server 20 and the electronic banking system 25, is installed in the electronic banking system 25 to provide the customers the financial transaction.

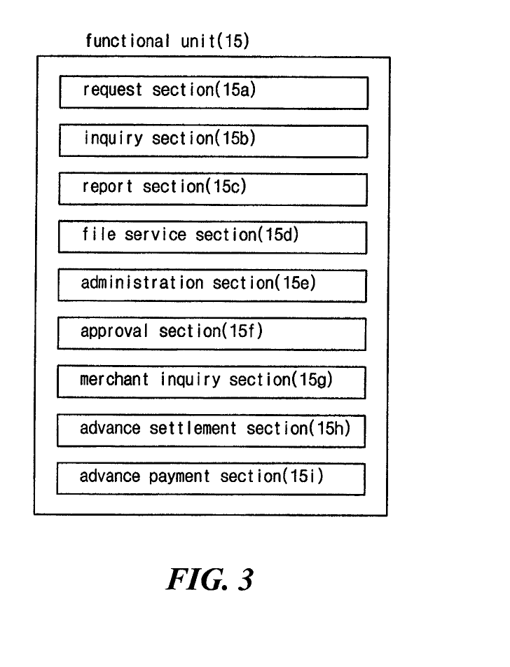

FIG. 3 illustrates a structural diagram of an exemplary functional unit of a corporation server of FIG. 1. As described before, the functional unit 15 is the software installed in the corporation server 10 of FIG. 1 in order to supply the corporation credit card information according to the present invention. As shown in FIG. 3, the functional unit 15 includes a request section 15a, an inquiry section 15b, a report section 15c, a file service section 15d, a administration section 15e, an approval section 15f, a merchant inquiry section 15g, an advance settlement section 15h and an advance payment section 15i.

The request section 15a requests the credit card company server 20 of FIG. 1 to transmit the corporation credit card information. This request includes the periodical use of each corporation credit card according to the corporation's necessities.

The inquiry section 15b provides the end users with the corporation credit card information through an intra-network or LAN. Namely, the end users get an access to the corporation server 10 (in FIG. 1) through the web browser or any other intra-network lool. and then the inquiry section 15b shows the information about all the corporation credit cards using the information received from the credit card company server 20 of FIG. 1. At this point, in order to obtain efficient references about all the credit cards owned by the corporation, the information providing for the end user is classified into basic information, detailed information, basic transaction information and detailed transaction information with reference to each corporation credit card.

The report section 15c helps the end users to make a report about the use of the corporation credit cards on the base of the information received from the credit card company server 20 of FIG. 1. This report section 15c provides the prearranged report format in accordance with the end user's necessities. And thus, the report about the use of the corporation credit cards is output in a certain report format. As examples provided to the end user, the report includes the transaction list in accordance to the credit card holders, the transaction history list about the merchants, the list of preferred and/or non-preferred merchants, the taxes, the accounts, etc.

The file service section 15d converts the data of the corporation server into the electronic files in order to transmit the information to the outside of the corporation server or vice versa. The information such as the card transaction can be utilized in an account department in the corporation, thus it can be formed in a file such as Microsoft Excel form. And another information, for example an authentication information in order to classify the authentication depending on the users ID can be made for example in an Excel form outside of the corporation server and then can be converted for the corporation server.

The administration section 15e administers the information including registration, authorization and authentication with respect to the credit card users. Here, the authentication is granted to the credit card users according to their duties. Further, the administration section 15e is in charges of administrating variable codes of banks, credit card companies and/or merchants.

The administration section 15e also includes a user registration, a user administration, a notice board, a help desk, etc. With respect to the user registration, the credit card user should input his or her information into the corporation server 10 of FIG. 1 by way of a terminal 1 and the information is stored at the user registry unit 12 which will be used for determining the access of the terminal, thereby obtaining the authentication from the corporation server 10. The information about the credit card user is used as data for checking the use of the credit card and for making a treasurer's report and a ledger. With respect to the administration, the administration section 15e also delegates authority to the credit card users and/or the administrator of the corporation credit card. With respect to the notice board, the administration section 15e provides variable information received from the credit card company. With respect to the help desk, the corporation requests the credit card company to provide the variable information that the corporation needs.

The approval section 15f functions as providing a direct payment system without an Internet payment service provider when the direct transaction with other corporation is complete using the corporation credit card. Namely, after the corporation credit card is issued from the credit card company, the corporation itself approves a credit transaction with other corporations through the approval section 15f, thereby simplifying the credit card transaction. The system of the approval section 15f is conducted by the terminal installed in the Palm PC or Handheld PC and/or by the POS (Point Of Sale) terminal, or the credit card user can input the transaction list into the corporation server 10. However, the corporation needs the permission from the credit card company before it uses the approval section 15f.

The merchant inquiry section 15g helps the end user to refer income information through this inventive system for the company. Thus, this section is used for distributor company registered to the card server or a distributor department of a buy-and-sell company. When the transaction approval of the corporation card happens in the card server, the card server stores the approval information which can be retrieved by request of this section 15g. Thus, this section cannot be used in a corporation server for a buy-only company. The corporation can look over the periodical credit card transaction (e.,g. daily and/or monthly transaction) or sales information processed through this inventive system. Additionally, the distributor corporation or the distributor department can check the status of the transaction (e.g. approval, purchase and/or payment) according as the corporation wants, thereby utilizing this information in the business planning of the corporation.

The advance settlement section 15h provides the function that asks the payment in advance in order to reduce the commission on the use of the corporation credit card. In other words, after receiving the information from the credit card company server 20 of FIG. 1, the advance settlement section 15h shows the user terminal 1 (in FIG. 1) the credit card list requiring the settlement in advance and the transaction list of each credit card requiring the advanced settlement. When the corporation selects and confirms the transaction list to be settled in advance, the information about the advanced settlement is transmitted to the credit card company server 20 and then the credit card company proceeds with their work on the advanced settlement.

The advance payment section 15i helps the corporation to directly pay the credit card bill in advance. Namely, if the advanced payment is required when the corporation looks into the transaction list of the corporation credit card, the corporation asks the credit card company to send the merchant's account number in order to make a remittance to the merchant's bank account. In the system of the advance payment section 15i, the advance payment section 15i receives the list of merchants that can accept the advanced payment and shows the transaction list on those merchants. Thereafter, the transaction list with the intention of the advanced payment is selected and transmitted to the credit card company server 20 of FIG. 1. Therefore, the credit card company handles the payment in advance.

According to the present invention, the corporate credit card user logs on the corporation server 10 through the user terminal 1, and monitors the information about the transaction history via the inquiry section 15b in accordance with each corporate credit card, a period (e.g., a daily transaction, a late weekly transaction, a late monthly transaction, etc.), a code of article, each merchant, each member, and each division and/or department of the corporation, etc. Additionally, since the credit card user obtains the report on the corporate credit card transaction using the report section 15c, the corporation can receives the accurate information about the corporate credit card and the corporation can use this information for its business planning. Further, it is possible that the corporation controls the use of the corporate credit card according to the divisions or departments and credit card users. Moreover, since the merchant inquiry section 15g provides the transaction history or state of the corporate credit card for the distributor, it is possible that the distributor can easily recognize the approval of the transaction by the credit card company server, can make a future plan, and can use this information when negotiating the price of the article or the contract basis with the major buyer.

As described herein, in order to efficiently utilize the functional unit 15, the corporation server 10 of FIG. 1 can readily supply a sort function (e.g., in a row or column), a detail inquiry function, a graphically outputting function, and so forth, each depending on the situation of each section of the functional unit 15. Whenever the corporation server 10 logs on the credit card company server 20, the latest transaction history or information is automatically updated to the corporation server 10. Further in order to get and maintain the software (i.e., the functional unit 15) in a lately updated version, the corporation server 10 logs on the credit card company server 20 and electronic banking system 25 providing the updated software. When installing the software (i.e., the functional unit 15), the users and/or corporations should input the identification information that is automatically transferred to the credit card company server 20 and electronic banking system 25. Therefore, whenever the users and/or corporations logs on the corporation server 10 in the future or the corporation server 10 interfaces with the credit card company server 20 and electronic banking system 25, the identification information (e.g., ID and Password) is required to authenticate the their membership for use in the user registry unit 12 and the membership authentication unit 20c. In the present invention, the functional unit 15 especially serves as an interface connecting the corporation server 10 to the credit card company server 20 through the Internet or other computer-implemented services because the network systems of the credit card companies and banks can be differentiated form each other. Simply stated, the functional unit 15 as a software unit for the present invention provides the corporate credit card information and transaction history by the way of connection with the credit card company server 20 and electronic banking system 25.

FIG. 2 illustrates a structural diagram of an exemplary credit card company server of FIG. 1. Each of the elements will be explained in detail.

The membership information database unit 20a stores the data about the credit card users including user's names, user's positions, contact point (e.g., telephone numbers, addresses, etc), resident registration numbers or business numbers, passwords, credit card numbers, and so forth.

The credit information database unit 20b has credit information of the credit card holders or individual or corporation.

The membership authenticating unit 20c gives the end users the permission using the date stored in the membership information database unit 20a. Therefore, the log-on of the each member is controlled by this membership authenticating unit 20b.

The information retrieval unit 20d receives the request about the credit card transaction history from the request section 15a of the corporation server 10. Therefore, the information retrieval unit 20d retrieves the information referring to the membership information database unit 20a and the credit card information database unit 20e, and generates the information data corresponding to the request.

The credit card information database unit 20e stores the credit card transaction history depending to the individual or corporation in order to respond to the request of the information retrieval unit 20d. The information of this unit 20e can be transferred to the credit information database unit 20b.

The communication unit 20f generally includes a variety of data communication devices and software. It functions as transmitting the data searched in the information retrieval unit 20c.

The approval inquiry unit 20g as an authorizer transmits the approval of credit card transaction to the corporation server 10. When the corporations want the direct credit transaction with the merchant or other corporations, they ask the credit card company for the transaction approval. Therefore, after obtaining the approval from the approval inquiry unit 20g of the credit card company server 20, the corporations can complete the credit transaction without the payment service provider.

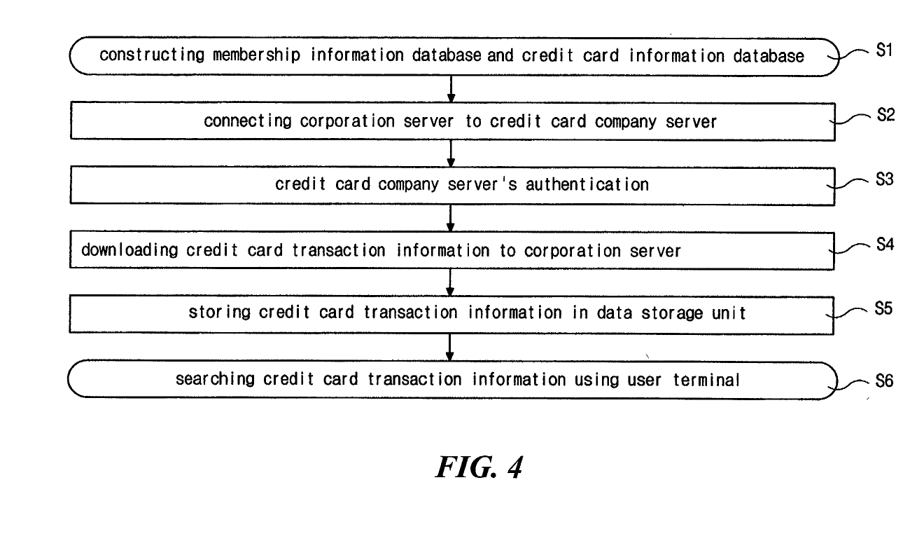

FIG. 4 is a data flow diagram showing how the data are processed by the system according to the first embodiment of the present invention. According to the present invention, a method for supplying credit card transaction information includes constructing a database having the corporate credit card transaction history according to each corporation; connecting the corporation server 10 to the credit card company server 20; requesting the credit card company server 20 to send the credit card transaction information; responding to the request of the corporation server 10; and searching the credit card transaction information sent to the corporation server 10 using the user terminal 1.

In step “S1” of FIG. 4, the credit card company classifies the information about the corporate credit card issued for each corporation, and constructs the membership information database and the credit card information database in the credit card company server 20. A user terminal 1 connects to the corporation server 10 which is connected to the card company server 20 over the Internet. At this time, the user registry unit 12 can be used for the access of the terminal 1 to the corporation server 10. Thereafter, the corporation server 10 logs on the credit card company server 20 through the communication unit 11 in accordance with the request of the request section 15a of the functional unit 15, i.e., step “S2.”

In step “S3”, the corporation server 10 connected to the credit card company server 20 requests the inquiry of the corporate credit card transaction history using the authentication key, such as ID, password, business number, credit card number, corporation's code. For a successful authentication, all authentication keys should be in accord with the information stored in the membership information database unit 20a or electronic banking system 25 by the membership authentication unit 20c. Further in step “S3”, the credit card company server 20 having conducted the successful authentication transmits the corporate credit card transaction approval to its information retrieval unit 20d.

Now in step “S4”, the credit card company server 20 searches the corporate credit card transaction information in the credit card information database 20e, and downloads the searched information to the corporation server 10. Thereafter, the corporation server 10 stores the downloaded information in the data storage unit 13 of FIG. 1, i.e., step “S5”. The information stored in the data storage unit 13 is used to make a report for the corporation's business planning. Especially, the prepared report can be sent to or stored in a computer-implemented inbound account system for use in taxes and accounts achievement.

Additionally in the present invention, it can automatically be performed that the corporation server 10 is connected to the credit card company server 20 and downloads the corporate credit card transaction information at a scheduled time. Namely, connecting and downloading are done in period, daily or weekly.

In step “S6”, the end user, who wants to see the transaction history or information of the corporate credit card, logs on the corporation server 10 using the user terminal 1 that is connected with the inbound communication infrastructure or local area network. Therefore, the end user can retrieves the information about the corporate credit card transaction. At this point, the corporation server 10 can be installed in each corporation or in a certain service provider providing a server according to the present invention. Therefore, the end user can accesses the corporation server 10 through the Internet or other network systems.

Moreover, the present invention provides the direct payment system without payment service provider, such as “Inicis.” Now referring back to FIG. 1, the corporation constructs a computer-implemented communication infrastructure or local area network including the corporation server 10. And then, the individual or corporation searches the articles in the on-line Internet shop using the user terminal 1. Thereafter, the users (individual or corporation) input the information, such as merchant name, merchant number, quantity, corporate credit card number, etc. The merchant number and the corporate credit card number are essential for credit transaction because the approval section 15f of the functional unit 15 requests the credit card company server 20 to approve the corporate credit card transaction using the inputted information. Accordingly, the approval inquiry unit 20g of the credit card company server 20 transmits the approval of the credit card transaction within the expenditure limit, thereby completing the direct credit transaction.

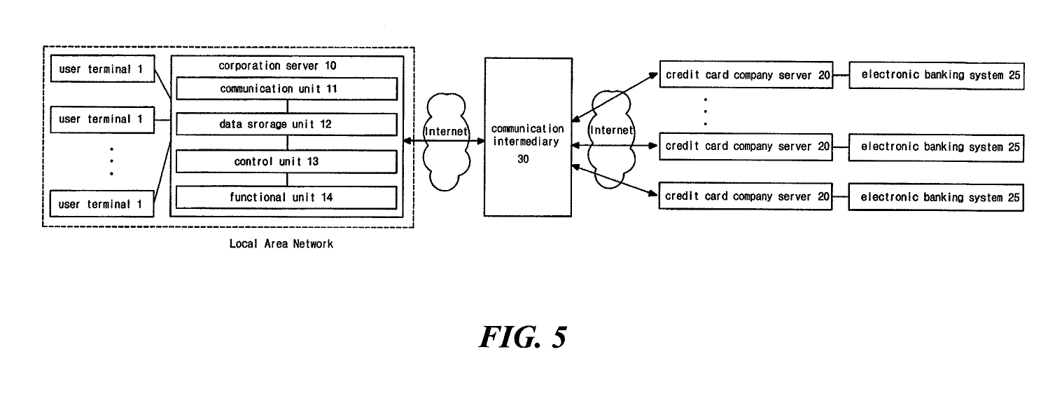

FIG. 5 is a schematic structural representation of a system for supplying corporate credit card information according to a second embodiment of the present invention. As shown in FIG. 5, the system for supplying the corporate credit card information includes a plurality of user terminals 1, a corporation server 10 installed in the corporation's infrastructure or intranet, a credit card company servers 20 each having electronic banking system 25, and a communication intermediary 30 in the Internet. As described above in the first embodiment of the present invention, the individual or corporation uses the corporate credit card information supply system through the corporation server 10 including the functional unit 15. However, in the second embodiment of the present invention, the communication intermediary 30 intermediates between the corporation server 10 and the credit card company server 20 or the electronic banking system 25. The communication intermediary 30 helps the credit card company that does not have the electronic banking system 25 or any communication systems connecting the Internet. Additionally, the communication intermediary 30 serves as an agency when the corporation server 10 can not directly contacts the credit card company server 20 or controls the information from the credit care company server 20. In other words, the communication intermediary 30 transmits the credit card transaction information to the corporation by way of converting the data from the credit card company server 20 to a format compatible with the corporation server 10. On the contrary, the communication intermediary 30 converts the data from the corporation server 10 to a format understood by the credit card company server 20.

As described hereinbefore, since the corporation credit card transaction information or history and the transaction approval are provided in the Internet or other on-line communication network according to the present invention, the corporation can easily gather accurate information about the transaction of the corporate credit card. Thereby controlling the transaction) of the credit card and negotiating the price with the merchant can be obtained.

It will be apparent to those skilled in the art that various modifications and variation can be made in the system and method for the electronic commerce without departing from the spirit or scope of the present invention. Thus, it is intended that the present invention cover the modifications and variations of this invention provided they come within the scope of the appended claims and their equivalents.

What is claimed is:

1. A system for supplying credit card information, comprising:
a user terminal,
a credit card company server including a membership information database unit storing member's information, a membership authenticating unit authorizing membership, a credit card information database unit storing information about the transaction of the credit card according to each individual and each corporation, an information retrieval unit searching the credit card transaction history in the credit card information database unit in accordance with a transmission request, an approval inquiry unit conducting the inquiry for the credit card transaction, and a communication unit transmitting the information found in the information retrieval unit and the answer to the credit card transaction approval inquiry; and
a corporation server including a communication unit controlling communication between the corporation server and outbound network systems, a data storage unit storing data generated in the corporation server, a control unit having an arithmetic unit, and a functional unit;
wherein the functional unit includes a request section requesting the credit card company server to transmit the credit card information, a inquiry section providing the user terminal with the corporation credit card information through an intranet or LAN, a report section helping an end user to make a report about the transaction of the corporation credit card on the base of the information received from the credit card company server, a file service section converting a data of the corporation into an electronic file in order to transmit the information to the outside of the corporation, and an administration section administering the credit card transaction information and history.

2. The system of claim 1, wherein the functional unit further includes an approval section that functions as providing a direct payment system without an Internet payment service provider when the direct transaction with other corporations is complete using the corporation credit card.

3. The system of claim 2, wherein the approval section is conducted by a terminal selected from a group consisting of a Palm PC, a Handheld PC and a POS (Point Of Sale) terminal.

4. The system of claim 1, wherein the functional unit further includes a merchant inquiry section that helps the user terminal to inquire about the transaction of the corporation credit card in order to know sale information through the system

5. The system of claim 1, wherein the functional unit further includes an advance settlement section that provides a function asking the credit card company server a payment in advance.

6. The system of claim 1, wherein the functional unit further includes an advance payment section that a corporation to directly pay a credit card bill in advance.

7. The system of claim 1, wherein the corporation server is a computer-implemented Internet access device.

8. The system of claim 1, wherein the data storage unit includes a cash memory, RAM, ROM and hard disks.

9. The system of claim 1, wherein the control unit includes a central processing unit (CPU).

11. The system of claim 1, wherein the credit card company server further includes an electronic banking system that cooperates with the credit card company server in supplying credit card information.

12. The system of claim 1 further comprising a communication intermediary that intermediates between the corporation server and the credit card company server, transmits the credit card information to the corporation server by way of converting the data from the credit card company server to a format compatible with the corporation server, and converts the data from the corporation server to a format understood by the credit card company server.

13. In a system for supplying credit card information which includes a user terminal, a corporation server connected to the user terminal through a computer-implemented communication infrastructure, and a credit card company server connected to the corporation server through the Internet, a method for supplying credit card information comprising the steps of:
constructing a database having corporate credit card transaction history and information according to each corporation in the credit card company server;
connecting the corporation server to the credit card company server;
requesting the credit card company server to send the credit card transaction information and history;
requesting a credit card transaction approval to the credit card company server;
responding to the request of the corporation server; and
searching the credit card transaction information and history sent to the corporation server using the user terminal 1.

14. The method of claim 13, wherein requesting the credit card transaction approval is conducted by a terminal selected from a group consisting of a Palm PC, a Handheld PC and a POS (Point Of Sale) terminal.
